(19) United States
(12) Patent Application Publication
(10) Pub. No.: US 2015/0146874 A1
(43) Pub. Date: May 28, 2015

(54) SIGNAL PROCESSING FOR AUDIO SCENE RENDERING

(71) Applicant: Juha Petteri Ojanpera, Nokia (FI)

(72) Inventor: Juha Petteri Ojanpera, Nokia (FI)

(73) Assignee: Nokia Corporation, Espoo (FI)

(21) Appl. No.: 14/360,298

(22) PCT Filed: Nov. 30, 2011
(86) PCT No.: PCT/IB2011/055392

§ 371 Date: Jul. 25, 2014

(51) Int. Cl. H04R 29/00

(52) U.S. Cl. CPC H04R 29/00; H04R 2430/00
USPC 381/56

(57) ABSTRACT

Apparatus has at least one processor and at least one memory having computer-readable code stored therein which when executed controls the at least one processor to perform a method. The method comprises processing first and second (5) sets of substantially live audio data originating from first and second devices respectively to determine whether the first and second devices are observing a common audio scene, processing orientation information originating from the first and second devices to determine whether the devices are similarly oriented, and triggering a first action in response to determining both that the first and second (10) devices are observing a common audio scene and that the first and second devices are similarly oriented.

### FIELD OF THE INVENTION

This invention relates to handling audio data.

### BACKGROUND TO THE INVENTION

It is known to distribute devices around an audio space and use them to record an audio scene. Captured signals are transmitted and stored at a rendering location, from where an end user can select a listening point based on their preference from the reconstructed audio space. This type of system presents numerous technical challenges.

In a typical multi-user environment, the users capturing the content may not be aware of other capturing users. For individual usage of the captured content this is not problematic.

### SUMMARY OF THE INVENTION

A first aspect of the invention provides a method comprising:
processing first and second sets of substantially live audio data originating from first and second devices respectively to determine whether the first and second devices are observing a common audio scene;
processing orientation information originating from the first and second devices to determine whether the devices are similarly oriented; and
triggering a first action in response to determining both that the first and second devices are observing a common audio scene and that the first and second devices are similarly oriented.

Each set of substantially live audio data may be obtained by transforming captured audio to a feature domain, for instance a frequency domain, and grouping the feature data into plural time frames. Here, adjacent time frames may be overlapping.

Processing the first and second sets of audio data to determine whether the first and second devices are observing a common audio scene may comprise:
correlating plural time-shifted data sets;
determining a time-shift that provides a maximum correlation;
comparing a result of the maximum correlation to a threshold;
determining that the first and second devices are observing a common audio scene when the threshold is exceeded; and
determining that the first and second devices are not observing a common audio scene when the threshold is not exceeded.

The first action may comprise indicating to a user an alternative orientation for either or both of the first and second devices.

Processing orientation information originating from the first and second devices to determine whether the devices are similarly oriented may comprise calculating orientations for each of the devices and comparing a difference between orientations to a threshold.

Calculating orientations for each of the first and second devices may comprise calculating dominant orientations for the first and second devices over a non-zero time period.

The method may comprise triggering a second action in response to determining both that the first and second devices are observing a common audio scene and that the first and second devices are not similarly oriented. Here, the second action may comprise indicating to a user that an alternative orientation is not needed.

The method may comprise performing the method of any preceding claim on server apparatus or alternatively on the second device.

A second aspect of the invention provides a computer program comprising instructions that when executed by computer apparatus control it to perform the method above.

A third aspect of the invention provides apparatus, the apparatus having at least one processor and at least one memory having computer-readable code stored therein which when executed controls the at least one processor to perform a method comprising:
processing first and second sets of substantially live audio data originating from first and second devices respectively to determine whether the first and second devices are observing a common audio scene;
processing orientation information originating from the first and second devices to determine whether the devices are similarly oriented; and
triggering a first action in response to determining both that the first and second devices are observing a common audio scene and that the first and second devices are similarly oriented.

The computer-readable code when executed may control the at least one processor to obtain each set of substantially live audio data by transforming captured audio to a feature domain, for instance a frequency domain, and grouping the feature data into plural time frames. Here, adjacent time frames may be overlapping.

The computer-readable code when executed may control the at least one processor to perform processing the first and second sets of audio data to determine whether the first and second devices are observing a common audio scene by:
correlating plural time-shifted data sets;
determining a time-shift that provides a maximum correlation;
comparing a result of the maximum correlation to a threshold;
determining that the first and second devices are observing a common audio scene when the threshold is exceeded; and
determining that the first and second devices are not observing a common audio scene when the threshold is not exceeded.

The computer-readable code when executed may control the at least one processor to perform the first action by indicating to a user an alternative orientation for either or both of the first and second devices.

The computer-readable code when executed may control the at least one processor to perform processing orientation information originating from the first and second devices to determine whether the devices are similarly oriented by calculating orientations for each of the devices and comparing a difference between orientations to a threshold.

The computer-readable code when executed may control the at least one processor to perform calculating orientations for each of the first and second devices by calculating dominant orientations for the first and second devices over a non-zero time period.

The computer-readable code when executed may control the at least one processor to perform triggering a second action in response to determining both that the first and second devices are observing a common audio scene and that the first and second devices are not similarly oriented. Here, the computer-readable code when executed may control the at least one processor to perform the second action by indicating to a user that an alternative orientation is not needed.

The apparatus may be server apparatus. Alternatively, the apparatus may be the second device.

A fourth aspect of the invention provides non-transitory computer-readable storage medium having stored thereon computer-readable code, which, when executed by computing apparatus, causes the computing apparatus to perform a method comprising:
processing first and second sets of substantially live audio data originating from first and second devices respectively to determine whether the first and second devices are observing a common audio scene;
processing orientation information originating from the first and second devices to determine whether the devices are similarly oriented; and
triggering a first action in response to determining both that the first and second devices are observing a common audio scene and that the first and second devices are similarly oriented.

The computer-readable code when executed by computing apparatus, may cause the computing apparatus to obtain each set of substantially live audio data by transforming captured audio to a feature domain, for instance a frequency domain, and grouping the feature data into plural time frames. Here, adjacent time frames may be overlapping.

The computer-readable code when executed by computing apparatus, may cause the computing apparatus to determine whether the first and second devices are observing a common audio scene by:
correlating plural time-shifted data sets;
determining a time-shift that provides a maximum correlation;
comparing a result of the maximum correlation to a threshold;
determining that the first and second devices are observing a common audio scene when the threshold is exceeded; and
determining that the first and second devices are not observing a common audio scene when the threshold is not exceeded.

The computer-readable code when executed by computing apparatus may cause the computing apparatus to perform the first action by indicating to a user an alternative orientation for either or both of the first and second devices.

The computer-readable code when executed by computing apparatus may cause the computing apparatus to perform processing orientation information originating from the first and second devices to determine whether the devices are similarly oriented by calculating orientations for each of the devices and comparing a difference between orientations to a threshold.

A fifth aspect of the invention provides apparatus comprising:
means for processing first and second sets of substantially live audio data originating from first and second devices respectively to determine whether the first and second devices are observing a common audio scene;
means for processing orientation information originating from the first and second devices to determine whether the devices are similarly oriented; and
means for triggering a first action in response to determining both that the first and second devices are observing a common audio scene and that the first and second devices are similarly oriented.

The apparatus may comprise means for obtaining each set of substantially live audio data by transforming captured audio to a feature domain, for instance a frequency domain, and means for grouping the feature data into plural time frames. Here, adjacent time frames may be overlapping.

The means for processing the first and second sets of audio data to determine whether the first and second devices are observing a common audio scene may comprise:
means for correlating plural time-shifted data sets;
means for determining a time-shift that provides a maximum correlation;
means for comparing a result of the maximum correlation to a threshold;
means for determining that the first and second devices are observing a common audio scene when the threshold is exceeded; and
means for determining that the first and second devices are not observing a common audio scene when the threshold is not exceeded.

The first action may comprise indicating to a user an alternative orientation for either or both of the first and second devices.

The means for processing orientation information originating from the first and second devices to determine whether the devices are similarly oriented may comprise means for calculating orientations for each of the devices and comparing a difference between orientations to a threshold.

The means for calculating orientations for each of the first and second devices may comprise means for calculating dominant orientations for the first and second devices over a non-zero time period.

The apparatus may comprise means for triggering a second action in response to determining both that the first and second devices are observing a common audio scene and that the first and second devices are not similarly oriented.

The second action may comprise indicating to a user that an alternative orientation is not needed.

The apparatus may be server apparatus. Alternatively, the apparatus may be the second device.

Embodiments of the invention will now be described, by way of example only, with reference to the accompanying drawings.

### BRIEF DESCRIPTION OF THE DRAWINGS

FIG. 1 shows audio scene with N capturing devices;

FIG. 2 is a block diagram of an end-to-end system embodying aspects of the invention;

FIG. 3 shows details of some aspects of the FIG. 2 system; and

FIG. 4 shows a high level flowchart illustrating aspects of embodiments of the invention.

### DETAILED DESCRIPTION OF EMBODIMENTS

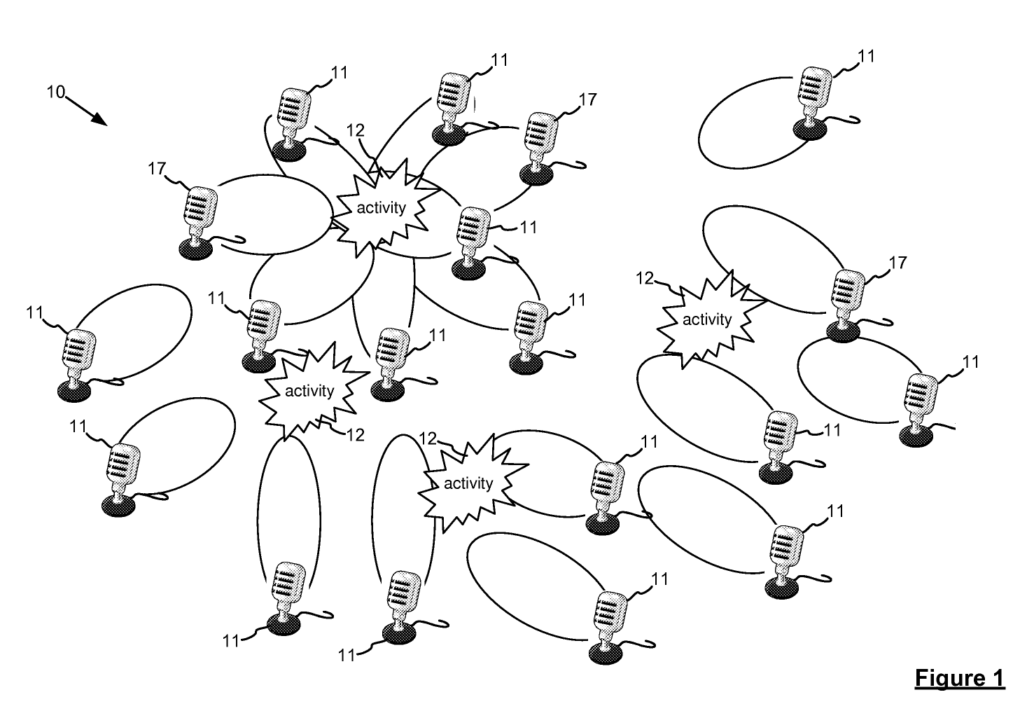

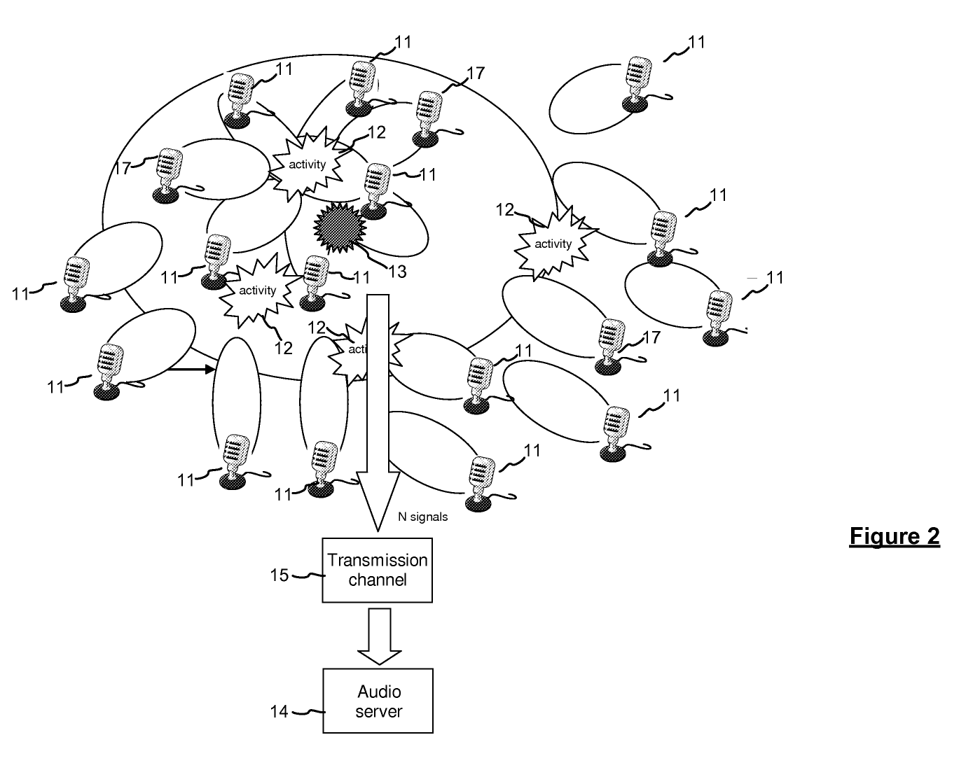

FIGS. 1 and 2 illustrate a system in which embodiments of the invention can be implemented. A system 10 consists of N devices 11, 17 that are arbitrarily positioned within the audio space to record an audio scene. In these Figures, there are shown four areas of audio activity 12. The captured signals are then transmitted (or alternatively stored for later consumption) so an end user can select a listening point 13 based on his/her preference from a reconstructed audio space. A rendering part then provides one or more downmixed signals from the multiple recordings that correspond to the selected listening point. In FIG. 1, microphones of the devices 11 are shown to have highly directional beam, but embodiments of the invention use microphones having any form of directional sensitivity. Furthermore, the microphones do not necessarily employ a similar beam, but microphones with different beams may be used. The downmixed signal(s) may be a mono, stereo, binaural signal or may consist of more than two channels, for instance four or six channels.

In an end-to-end system context, the framework operates as follows. Each recording device 11 records the audio scene and uploads/up streams (either in real-time or non real-time) the recorded content to an audio server 14 via a channel 15. The upload/upstream process provides also positioning information about where the audio is being recorded and the recording direction/orientation. A recording device 11 may record one or more audio signals. If a recording device 11 records (and provides) more than one signal, the direction/orientation of these signals may be different. The position information may be obtained, for example, using GPS coordinates, Cell-ID or A-GPS. Recording direction/orientation may be obtained, for example, using compass, accelerometer or gyroscope information.

Ideally, there are many users/devices 11, 17 recording an audio scene at different positions but in close proximity. The server 14 receives each uploaded signal and keeps track of the positions and the associated directions/orientations.

Initially, the audio scene server 14 may provide high level coordinates, which correspond to locations where user uploaded/up streamed content is available for listening, to an end user device 11, 17. These high level coordinates may be provided, for example, as a map to the end user device 11, 17 for selection of the listening position. The end user device 11, 17 or e.g. an application used by the end user device 11, 17 is has functions of determining the listening position and sending this information to the audio scene server 14. Finally, the audio scene server 14 transmits the downmixed signal corresponding to the specified location to the end user device 11, 17. Alternatively, the audio server 14 may provide a selected set of downmixed signals that correspond to listening point and the end user device 17 selects the downmixed signal to which he/she wants to listen. Furthermore, a media format encapsulating the signals or a set of signals may be formed and transmitted to the end user devices 17.

Embodiments of this specification relates to immersive person-to-person communication including also video and possibly synthetic content. Maturing 3D audio-visual rendering and capture technology facilitates a new dimension of natural communication. An ‘all-3D’ experience is created that brings a rich experience to users and brings opportunity to new businesses through novel product categories.

To be able to provide compelling user experience for the end user, the multi-user content itself must be rich in nature. The richness typically means that the content is captured from various positions and recording angles. The richness can then be translated into compelling composition content where content from various users are used to re-create the timeline of the event from which the content was captured. In a typical multi-user environment, the users capturing the content may not be aware of other capturing users. For individual usage of the captured content this does not create a problem but when users are also planning to release the captured content for multi-user sharing service where the content is re-mixed with content from other users, problems may arise because the content was captured in uncontrolled manner (from the multi-user content composition point of view). T It is an aim of embodiments of this specification to provide a mechanism to notify a capturing user if other users are already capturing the same event scene as the user in question and provide capturing hints that improve the re-mixing of the content in the multi-user content composition context.

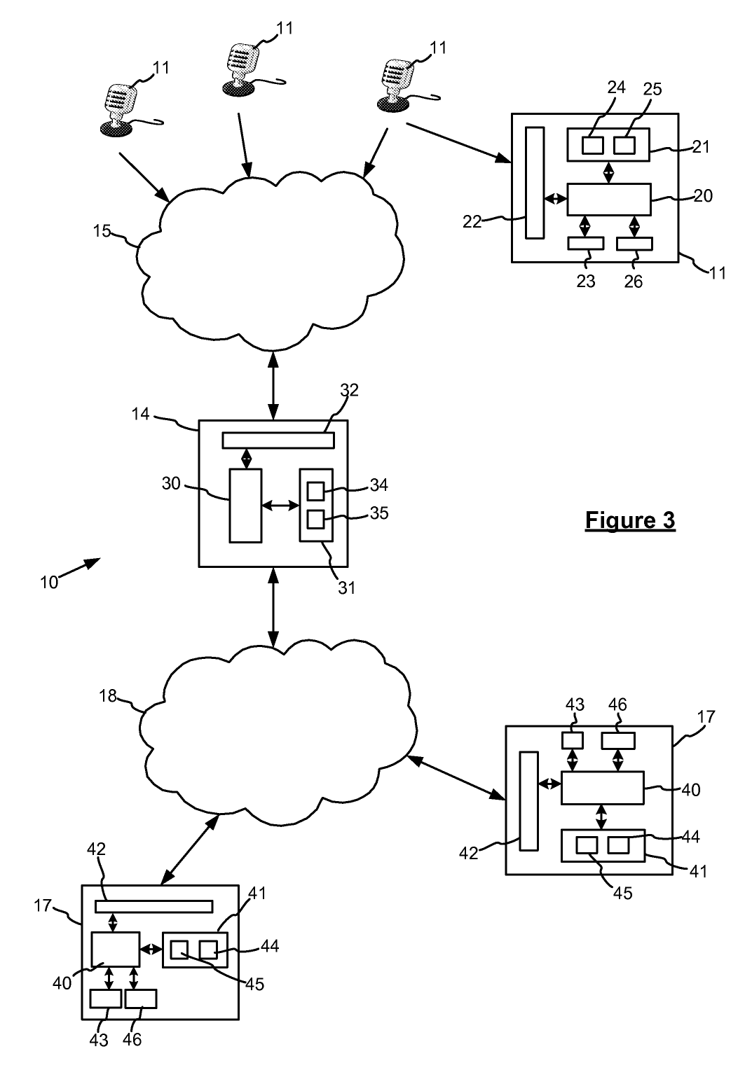

FIG. 3 shows a schematic block diagram of a system 10 according to embodiments of the invention. Reference numerals are retained from FIGS. 1 and 2 for like elements. In FIG. 3, multiple end user first recording devices 11 are connected to a server 14 by a first transmission channel or network 15. The first user devices 11 are used for detecting an audio scene for recording. The first user devices 11 may record audio and store it locally for uploading later. Alternatively, they may transmit the audio in real time, in which case they may or may not also store a local copy. The first user devices 11 are referred to as recording devices 11 because they record audio, although they may not permanently store the audio locally.

The server 14 is connected to other end user recording devices 17 via a second transmission channel 18. The first and second channels 15 and 18 may be different channels or networks or they may be the same channel or may be different channels within a single network.

Each of the first recording devices 11 is a communications device equipped with a microphone. Each first device 11 may for instance be a mobile phone, smartphone, laptop computer, tablet computer, PDA, personal music player, video camera, stills camera or dedicated audio recording device, for instance a dictaphone or the like.

The first recording device 11 includes a number of components including a processor 20 and a memory 21. The processor 20 and the memory 21 are connected to the outside world by an interface 22. At least one microphone 23 is connected to the processor 20. The microphone 23 is to some extent directional. If there are multiple microphones 23, they may have different orientations of sensitivity. The processor is also connected to an orientation sensor 26, such as a magnetometer.

The memory 21 may be a non-volatile memory such as read only memory (ROM) a hard disk drive (HDD) or a solid state drive (SSD). The memory 21 stores, amongst other things, an operating system 24 and at least one software application 25. The memory 21 is used for the temporary storage of data as well as permanent storage. Alternatively, there may be separate memories for temporary and non-temporary storage, such as RAM and ROM. The operating system 24 may contain code which, when executed by the processor 20 in conjunction with the memory 25, controls operation of each of the hardware components of the device 11.

The one or more software applications 25 and the operating system 24 together cause the processor 20 to operate in such a way as to achieve required functions. In this case, the functions include processing audio data, and may include recording it. As is explained below, the functions include processing audio data to derive feature data therefrom.

The audio server 14 includes a processor 30, a memory 31 and an interface 32. Within the memory 31 are stored an operating system 34 and one or more software applications 35.

The memory 31 may be a non-volatile memory such as read only memory (ROM) a hard disk drive (HDD) or a solid state drive (SSD). The memory 31 stores, amongst other things, an operating system 34 and at least one software application 35. The memory 31 is used for the temporary storage of data as well as permanent storage. Alternatively, there may be separate memories for temporary and non-temporary storage, e.g. RAM and ROM. The operating system 34 may contain code which, when executed by the processor 30 in conjunction with the memory 35, controls operation of each of the hardware components of the server 14.

The one or more software applications 35 and the operating system 34 together cause the processor 30 to operate in such a way as to achieve required functions. In this case, the functions may include processing received audio data to derive basis vectors therefrom. The functions may also include processing basis vectors to derive alignment information therefrom. The functions may also include processing alignment information and audio to render audio therefrom.

Within the second recording devices 17, a processor 40 is connected to a memory 41 and to an interface 42. An operating system 44 is stored in the memory, along with one or more software applications 45. At least one microphone 43 is connected to the processor 40. The microphone 43 is to some extent directional. If there are multiple microphones 43, they may have different orientations of sensitivity. The processor 40 is also connected to an orientation sensor 46, such as a magnetometer.

The memory 41 may be a non-volatile memory such as read only memory (ROM) a hard disk drive (HDD) or a solid state drive (SSD). The memory 41 stores, amongst other things, an operating system 44 and at least one software application 45. The memory 41 is used for the temporary storage of data as well as permanent storage. Alternatively, there may be separate memories for temporary and non-temporary storage, e.g. RAM and ROM. The operating system 44 may contain code which, when executed by the processor 40 in conjunction with the memory 45, controls operation of each of the hardware components of the second recording device 17.

The one or more software applications 45 and the operating system 44 together cause the processor 40 to operate in such a way as to achieve required functions. In this case, the functions include processing audio data to feature data therefrom. The functions may also include processing feature data and orientation data provided by the second recording device 17 and the recording device 11 and orientation data to determine whether the second recording device 17 could improve the multi-user sharing service by changing to a different orientation of the device 17.

Each of the first user devices 11, the audio server 14 and the second recording devices 17 operate according to the operating system and software applications that are stored in the respective memories thereof. Wherein the following one of these devices is said to achieve a certain operation or provide a certain function, this is achieved by the software and/or the operating system stored in the memories unless otherwise stated.

Audio recorded by a recording device 11, 17 is a time-varying series of data. The audio may be represented in raw form, as samples. Alternatively, it may be represented in a non-compressed format or compressed format, for instance as provided by a codec. The choice of codec for a particular implementation of the system may depend on a number of factors. Suitable codecs may include codecs that operate according to audio interchange file format, pulse-density modulation, pulse-amplitude modulation, direct stream transfer, or free lossless audio coding or any of a number of other coding principles. Coded audio represents a time-varying series of data in some form.

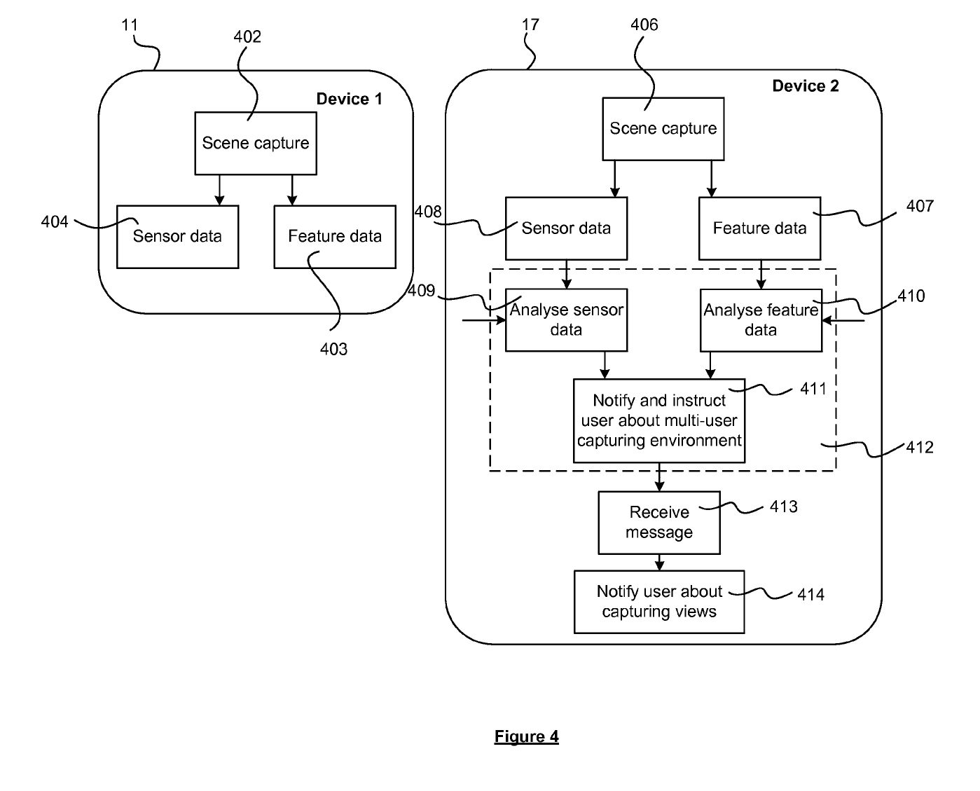

FIG. 4 shows a high level exemplary block diagram of the invention. In the figure, the system is shown to include the first and second recording devices 11, 17. The first device 11 starts the content scene capturing 402. While capturing, sensor data 404 and feature data 403 corresponding to the captured content is sent to other devices, including the second device 17. The second device 17 also starts a capturing process 406. While capturing, the second device 17 receives a notification 413 (e.g. from the server 14) that the event scene is also being captured by other users. The second device 17 then determines and provides suggestions 414 for better content capturing from the multi-user capturing point of view.

There are two main alternatives for the processing of data. In a first set of embodiments, analysis of the sensor and feature data is applied in the server 14 and the server 14 notifies and instructs 411 the second device 17.

In other embodiments, the processing is performed on the second device 17. Here, transmission of the sensor data 404 and feature data 403 is over an ad-hoc (broadcast) radio signal connecting the first and second devices 11, 17 without any need for external network communication. Analysis and subsequent notification and instruction phase 411 is performed in the second recording device 17. Here, the server 14 may be omitted, or used for storing recorded audio and/or post-processing.

As the second device 17 is made aware of other devices that are also capturing the same event scene, improved multi-user composition content can be made available by providing suggestions to the users of the devices 11, 17 about different capturing features in the multi-user content capturing context.

Next, elements of FIG. 4 in accordance with an embodiment of the invention are explained in more detail.

First, in step 402, the first device 11 starts capturing content from the event scene 402. As content is being captured, the feature data 404 and sensor data 403 is extracted for analysis purposes. The feature data is extracted from the captured content according to following steps:

The audio signal of the captured content is first transformed to a feature domain (FD) representation. The FD operator is applied to each signal segment according to:

X[bin,l]=FD(x_{bin,l,T}) (1)

where bin is the frequency bin index, l is time frame index, T is the hop size between successive segments, and FD( ) the time-to-frequency operator. In the current implementation, the FD operator is as follows:

$$FD ( {x}_{m , bin , l , T} ) = \frac{{\sum }_{n = 0}^{{N}_{f} - 1} ( fw ( n ) \cdot {e}^{- j \cdot {w}_{bin} \cdot n} )}{log 10 ( \vert {\sum }_{n = 0}^{N \_ MFCC - 1} tw ( n ) \vert )} \\ tw ( n ) = {MFCC}_{n} ( x ( l \cdot T ) ) , 0 \leq n < N\_MFCC \\ fw ( n ) = tw ( n ) , 0 \leq n < N\_MFCC \\ fw ( N + n ) = 0 , N \leq n < {N}_{f} \\ where {w}_{bin} = \frac{2 \cdot π \cdot bin}{{N}_{f}} , {N}_{f} \qquad ( 2 )$$

is the size of the FD( ) operator transform, MFCCₙ( ) is the operator that calculates the n^{th} Mel-frequency cepstral coefficient for the specified signal segment of length 2N, and N_MFCC is the number of MFCCs to be generated. To obtain continuity and smooth coefficients over time, the hop size is set to T=N/2, that is, the previous and current signal segments are 50% overlapping. As can be seen, the MFCCs samples are converted to the Fourier domain which is the final feature domain in the current implementation. Naturally, the frequency domain representation of the MFCCs samples may also be obtained using DCT, MDCT/MDST, QMF, complex valued QMF or any other transform that provides frequency domain representation. Equation (1) is calculated on a frame-by-frame basis where the size of a frame is of short duration, for example, 20 ms (typically less than 50 ms).

To summarise, each series of audio data is converted to another domain, here the frequency domain.

The raw feature data is then mapped into data elements for transmission according to:

Pseudo-code 1:

| | |
|---|---|
| 1 | nWindowElements = └sRes/tRes + 0.5┘ |
| 2 | nElements = └L/nWindowElements + 0.5┘ |
| 3 | |
| 4 | For t = 0 to nElements − 1 |
| 5 | |

| | |
|---|---|
| 6 | tStart = t * nWindowElements |
| 7 | tEnd = tStart + twNext * nWindowElements |
| 8 | If tEnd > L |

| | |
|---|---|
| 9 | tEnd = L |

| 10 | |
|---|---|
| 11 | bV_{bx}(t) = fD_{bx}(tStart,tEnd) |

| | |
|---|---|
| 12 | Endfor |

where sRes describes the sampling resolution of the data elements, tRes is the time resolution of the frames according to tRes=N/(2*Fs), Fs is the sampling rate of the audio signal, L is the number of time frames present for the signal, and twNext describes the time period each element in the feature data vector is covering at each time instant. To summarise, the number of window elements is set to a function of the sampling resolution of the basis vectors and the time resolution of frames. The number of elements is then set to a function of the number of time frames present for the series and the number of window elements. For each element, a start time is set to a function of time and the number of window elements and end time is set to a function of start time, the time period each element in the basis vector is covering at each time instant and the number of window elements. This is performed for each time frame. Then, the basis vector value is determined by applying a function to the data between the start time and end time and assigning the result of applying the function to basis vector index t.

The value of fD_{bx} in line 11 is calculated according to

$${fD}_{bx} ( tStart , tEnd ) = std ( cSum ) , cSum = {\sum }_{bk = 2 \cdot bx}^{2 \cdot bx + 1} {\sum }_{k = tStart}^{tEnd - 1} X ( binIdx ( bk ) , k ) \qquad ( 3 )$$

where binIdx( ) returns the frequency bin indices to be included in the calculation and Bk is the number of bin indices to be used.

To summarise, the frequency domain in the sampling period is calculated to be the sum of all frequency bins that make up X at any instant k between start and end times.

Furthermore, std(y) calculates the standard deviation of y according to

$$std ( y ) = \sqrt{\frac{1}{length ( y ) - 1} \cdot {\sum }_{i = 0}^{length ( y ) - 1} {( y ( i ) - \overline{y} )}^{2}} , \\ \overline{y} = \frac{1}{length ( y )} \cdot {\sum }_{i = 0}^{length ( y ) - 1} y ( i ) \qquad ( 4 )$$

where length(y) returns the number of samples present in vector y. Equation (6) is repeated for

$$0 \leq bx < \frac{Bk}{2} .$$

In the current implementation, the binIdx for the TF( ) operator is set to

$$binIdx ( k ) = ⌊ \frac{f ( k ) \cdot 2 \cdot N}{Fs} ⌋ , 0 \leq k < Bk \\ f ( k ) = \{ \begin{matrix}4 , & k = 0 \\ 8 , & k = 1\end{matrix} \qquad ( 5 )$$

where Fs is the sampling rate of the source signals and f( ) describes the frequencies to be covered, both in Hz.

To summarise, the mean of length y is a function of the reciprocal of length y and the sum of all y. Standard deviation of length y is the root of the product of the reciprocal of length y and the sum of y minus the average of y all squared. A frequency bin index, which depends on an integer k, is calculated as a function of the reciprocal of the sampling rate, and frequencies covered for a period N.

The mapping of raw feature data into data elements in pseudo-code 1 is shown for the whole captured content. The data elements are calculated once enough raw feature data is available. In the current example, the values of sRes, and twNext are set 0.25 s and 2.5 s, respectively. Thus, in order to output one data value, 2.5 s worth of future audio data in the feature domain is available and 4 samples are determined per second. sRes may alternatively take a value between 0.05 and 1.25 second. twNext may take a value between 0.5 seconds and 12.5 seconds.

It will be appreciated from the above that the feature data is generated/transmitted substantially live, i.e. the feature data relates to audio that was very recently, of the order of a few seconds, captured.

The transmission of the data element may occur immediately once the data value is available. Alternatively, the data elements may be grouped, for example, to 4 successive samples, and then transmitted. As the sampling resolution of the data elements from the raw feature data is very small compared to the typical sampling resolution of an audio signal, the overhead in transmitting the data elements in the overall system context is negligible.

The sensor data 404 in the current examples consists of magnetometer (compass) values. The transmission resolution of these values may also follow the resolution of the feature data 403. However, due to the nature of the capturing, that is, as content is typically captured from certain direction for a long period of time with little changes in the compass values, it may be advantageous that the transmission resolution of the magnetometer values follow the capturing characteristics. Therefore, the values may be transmitted periodically, for example, once every second or once every two seconds; or only when the compass value changes from the previously transmitted valued by a threshold amount, for example, ±10°.

For the step of analysis of the feature data 410, the second device 17 receives the feature data from the transmitting device 11. The received data 403 is then compared against the feature data elements determined from the second device's own captured content 407. It will be appreciated from the above that this feature data is generated substantially live, i.e. the feature data relates to audio that was very recently, of the order of a few seconds, captured. The two data sets are analysed and the result is then outputted to step 411 that is configured to prepare the user notification message. The analysis may be performed once enough data elements are available for the analysis. This value is quite implementation-specific but typically at least several seconds of feature data are appropriate to provide robust analysis.

As mentioned above, in some embodiments, steps 409-411 may be performed on the second device 17. Alternatively they may be performed on the server 14.

Next, the analysis steps are detailed as follows. Let the received feature data set be x and the local device data set be y, then the analysis that determines whether the data pair is coming from the same event scene is according to

corrXY_{x,y}=└xCorr_{x- x̅,y− y̅,1}xCorr_{y- y̅,x− x̅,−1}┘ (6)

where

$${xCorr}_{x , y , sign} ( k ) = sign \cdot {xC}_{k} , 0 \leq k < xLen \\ xLen = length ( x ) , yLen = length ( y ) \\ {xC}_{k} = \frac{sum 0}{\sqrt{sum 1 \cdot energy}} \\ energy = {\sum }_{lIdx = k}^{m i n ( xLen , yLen ) - 1} {x [ iIdx ]}^{2} ; sum 0 = {\sum }_{lIdx = k}^{m i n ( xLen , yLen ) - 1} x [ lIdx ] \cdot y [ lIdx - k ] ; sum 1 = {\sum }_{lIdx = k}^{m i n ( xLen , yLen ) - 1} {y [ lIdx - k ]}^{2} \qquad ( 7 )$$

where min( ) return the minimum value of the specified values.

In summary, the correlation of the data pair (x,y) for index k is a function of the sign variable and the cross-correlation xC. The cross-correlation is a function of normalized length of data pair (x,y) at index k and the ratio of the cross-correlation value. The nominator of the cross-correlation value is calculated to be the sum of the product of x and y at indices defined by k and length of the data pair. The denominator of the cross-correlation value is the root of the product of the sum of the delayed data vector y squared and the sum of the data vector x squared.

The maximum correlation is then determined according to

xymaxCorr=max(|corrXY_{x,y}|) (8)

where max( ) returns the maximum absolute value of the specified input vector. If the maximum correlation exceeds a certain confidence threshold, which in the current implementation is set to 0.6, the analysis concludes that the data sets are correlated, thus, are from the same event scene and therefore user need to be notified of this in case the user desirers to adjust his/her content capturing to improve the multi-user content composition. The correlation analysis result is therefore

$$shared\_capture = \{ \begin{matrix}is\_shared , & xymaxCorr > 0.6 \\ not\_shared & otherwise\end{matrix} \qquad ( 9 )$$

Furthermore, the results from Equation (8) are used also to extract the time offset between the data sets. Due to the feature data formation and various transmission delays, the data sets are not perfectly aligned, so the vector index that corresponds to the maximum absolute value indicates the time offset between the data pairs. If the index corresponds to the first vector element of Equation (6) (where sign is set to 1) then the second device data needs to be delayed with respect to the received data set (as indicated by the index), and if the index corresponds to the second vector element of Equation (6) (where sign is set to −1) then the received data set needs to be delayed with respect to the second device set (where the index value is subtracted by the length of the first vector element). This same analogy may also be used to align the sensor data sets in the sensor data analysis block 409.

The analysis of the sensor data 409 follows the same high level steps as already detailed for the feature data analysis 410. The analysis for the sensor data 409 comprising the compass values is detailed as follows. First, the compass value covering the magnetometer values of the second device are calculated that covers the same time period as the received compass values from the first device. Then the dominant compass value is calculated for both data sets that describe the orientation of the device, namely the direction in which the device is pointing, for most of the time.

In some embodiments, the determination of the dominant compass value is achieved using histogram analysis. Alternatively, it may be achieved by calculating the mean and removing outliers as determined by the standard deviation of the corresponding compass values in iterative manner.

Once dominant directions are known for both sets, the difference direction is calculated and outputted for further processing. The difference direction is therefore according to:

diff=(diff_local−diff_received)modulo 360° (10)

where diff_local is the dominant direction for the second device and diff received is the dominant direction for the received sensor data.

To summarise, the difference direction is calculated by subtracting the dominant direction for the received sensor data from the dominant direction for the second device all multiplied by the modulo of angle.

The feature and sensor data analysis results are then inputted to step 411 and the following exemplary notification and instruction message for the user of the device 17 are made available:

If shared capture is equal to is shared:
Message1: “Multi-user capturing scene detected”

This message 411 is followed by a message 414 that contains instructions based on sensor data analysis. The message 414 for instructing the user about possible view adjustments for the content capturing takes into account the dominant compass direction for the second device and for the received sensor data. If difference direction is within some pre-defined threshold, for example, ±10°, the user is provided with a message indicating that other users are already covering this view and for better content composition is may be advantageous that the user adjusts the capturing view. The adjustment may be given such that it is outside the threshold by some degree or user may be given a list of compass views that are yet to be discovered. In case the difference direction is not within the threshold, it may be advantageous that the user is not given any new view change as the current view is not covered by others.

In these situations, the message may be provided as follows:

If diff greater than diff_threshold (e.g., ±10°)
Message2: “No actions needed”
else
Message2: “Following positions uncovered” <list of compass directions that might provide enhanced experience for the multi-user content composition>.

It is to be noted that the dominant compass angles for each of the devices in the event scene are tracked and stored to create a global view to the dominant compass angles. In some embodiments, the dominant compass angles may be stored by the devices 11, 17 as in the ad-hoc network each device 11, 17 receives the transmissions of the other devices 11, 17. Alternatively the dominant compass angles may be stored in the server 14.

Once the second device 17 receives the notification message 414 and it contains relevant instructions (that is, compass view adjustment(s)) for the user, the new compass angle(s) are presented, typically displayed, on the device 17. The exact method for showing is outside the scope of the invention but it can be a separate application that relays the message or the new view can be overlaid to the capturing screen to minimize interruptions to the actual capturing process. The user can then smoothly change the view to move to a completely new position that better matches the new view angle.

### Else

Message1: “Single-user capturing scene detected”

In this case, it may be advantageous that the user is not notified at all since there is no action needed by the user. Notifying the user that no other capturing users were found would only interfere the capturing and provide no beneficial information to the user.

The above description relates to two devices 11, 17 in the scene but it will be appreciated that it can be easily extended to three or more devices. In the case of a system with more than two devices, the feature data analysis is applied to each received data set from various devices 11, 17 and the sensor data analysis for those sensor data sets which were identified to belong to same event scene based on the feature data analysis.

Furthermore, in some embodiments, the analysis and message generation are performed on a regular basis, say for every 30 s, or another basis between 10 s and 240 s, to achieve up to date capturing. The analysis result improves as the amount of data received increases.

In some embodiments, it may also be advantageous that global positioning information, such as GPS or Cell-ID, is used as a pre-processing step to exclude data sets that do not share the same capturing location. This step can be used to eliminate events that are known for sure to be in different locations. This reduces audio data processing performed within the system.

In addition, it may beneficial in certain embodiments that the correlation threshold affects also the system operation. For example, for threshold values 0.6, 0.7, 0.8, and 0.9 the system may use different view positioning. If feature data sets are correlated say by amount of 0.6 as indicated by Equation (8), is may be concluded that the capturing devices are not necessarily closely located. In this case, it may be advantageous that devices that roughly share the same correlation level, that is close to say, 0.8 or more are notified and provided with capturing hints where the view resolution is much finer than for devices with weaker correlation status. Thus, in these embodiments, devices with correlation level 0.9 or more may be offered view adjustment hints such that a capturing view would be available with high compass plane resolution for the multi-user content composition, for example, from compass angles 0°, 5°, 10°, 355°. Correlation level 0.8 or more may be offered view adjustment hints or suggestions that try to cover angles 0°, 10°, 20°, . . . , 350° and so on.

The resolution can alternatively be reversed so that correlation level 0.9 or more may be offered view adjustment suggestions such that a capturing view would be available with coarse compass plane resolution for the multi-user content composition, for example, from compass angles 0°, 90°, 180°, . . . , 270°. Correlation level 0.8 or more may be offered view adjustment hints that try to cover angles 0°, 45°, 90°, . . . , 315° and so on.

The sensor data may also be produced by additional sensor elements such as accelerometer or gyro data. Such sensors can be used to detect tilting of the device 11, 17 and/or detect whether any undesired shaking of the device is occurring during capturing. For example, data processing, recording and/or user notification may be suspended or ceased if it determined that the microphone is oriented downwards towards the ground and/or if the device seems to be shaking or vibrating too much during the analysis period.

An effect of the above-described embodiments is the possibility to improve multi-user scene capture. This can be achieved efficiently for identifying event scenes with shared capture because information flow between devices can be low compared to the information comprising the captured content. The embodiments can be said to improve the identification of shared event scene capture by utilizing feature data from the actual captured content.

The above-described embodiments perform favourably compared to other possible ways of achieving a similar result. For instance, the use of GPS or Cell-ID, possibly in a client-server architecture, to acquire whether other users are capturing in the nearby locations already would have the disadvantage in that the area they are covering or the precision they are providing may be insufficient. GPS is well-known for its errors in positioning that may range from 5-15 meters. Also GPS does not work properly indoors. The geographical area that Cell-ID covers may be so large that several events easily fit into the coverage of the ID.

Also, different broadcast networking techniques in use, such as Bluetooth, could be used to indicate the presence of a content capturing. The network, however, would not be able to limit the propagation of this indication to a limited area and it is quite possible that any indication of a presence of a content capturing is also received by other event scenes depending on the type of event. For example, it may be such that within a small geographical area there are actually many events. This interference may actually end up in worsening the multi-user content composition as events are not correlated but users and/or devices are not capable of detecting this situation.

Although the above embodiments relate to solely audio data, the scope of the invention is not limited to this. For instance, the invention is applicable also to processing substantially live video and other content that includes an audio component.

1-40. (canceled)

41. A method comprising:
processing first and second sets of substantially live audio data originating from first and second devices respectively to determine whether the first and second devices are observing a common audio scene;
processing orientation information originating from the first and second devices to determine whether the devices are similarly oriented; and
triggering a first action in response to determining both that the first and second devices are observing a common audio scene and that the first and second devices are similarly oriented.

42. The method as claimed in claim 41, wherein each set of substantially live audio data is obtained by transforming captured audio to a feature domain and grouping the feature data into plural time frames.

43. The method as claimed in claim 42, wherein adjacent time frames are overlapping.

44. The method as claimed in claim 41, wherein processing the first and second sets of audio data to determine whether the first and second devices are observing a common audio scene comprises:
correlating plural time-shifted data sets;
determining a time-shift that provides a maximum correlation;
comparing a result of the maximum correlation to a threshold;
determining that the first and second devices are observing a common audio scene when the threshold is exceeded; and
determining that the first and second devices are not observing a common audio scene when the threshold is not exceeded.

45. The method as claimed in claim 41, wherein the first action comprises indicating to a user an alternative orientation for either or both of the first and second devices.

46. The method as claimed in claim 41, wherein processing orientation information originating from the first and second devices to determine whether the devices are similarly oriented comprises calculating orientations for each of the devices and comparing a difference between orientations to a threshold.

47. The method as claimed in claim 41, wherein calculating orientations for each of the first and second devices comprises calculating dominant orientations for the first and second devices over a non-zero time period.

48. The method as claimed in claim 41, comprising triggering a second action in response to determining both that the first and second devices are observing a common audio scene and that the first and second devices are not similarly oriented.

49. The method as claimed in claim 48, wherein the second action comprises indicating to a user that an alternative orientation is not needed.

50. The method comprising performing the method of claim 41 on a server apparatus.

51. The method comprising performing the method of any of claim 41 on the second device.

52. An apparatus comprising at least one processor and at least one memory including computer code, the at least one memory and the computer code configured to with the at least one processor cause the apparatus to:
process first and second sets of substantially live audio data originating from first and second devices respectively to determine whether the first and second devices are observing a common audio scene;
process orientation information originating from the first and second devices to determine whether the devices are similarly oriented; and
trigger a first action in response to determining both that the first and second devices are observing a common audio scene and that the first and second devices are similarly oriented.

53. The apparatus as claimed in claim 52, wherein each set of substantially live audio data is obtained by the apparatus being caused to transform the captured audio to a feature domain, and grouping the feature data into plural time frames.

54. The apparatus as claimed in claim 53, wherein adjacent time frames are overlapping.

55. The apparatus as claimed in claim 52, wherein the apparatus is caused to process the first and second sets of audio data to determine whether the first and second devices are observing a common audio scene by being caused to:
correlate plural time-shifted data sets;
determine a time-shift that provides a maximum correlation;
compare a result of the maximum correlation to a threshold;
determine that the first and second devices are observing a common audio scene when the threshold is exceeded; and
determine that the first and second devices are not observing a common audio scene when the threshold is not exceeded.

56. The apparatus as claimed in claim 52, wherein the apparatus s caused to perform the first action by being caused to indicate to a user an alternative orientation for either or both of the first and second devices.

57. The apparatus as claimed in claim 52, wherein the apparatus is caused to perform processing orientation information originating from the first and second devices to determine whether the devices are similarly oriented by being caused to calculate orientations for each of the devices and comparing a difference between orientations to a threshold.

58. The apparatus as claimed in claim 52, wherein the apparatus is caused to perform calculating orientations for each of the first and second devices by being caused to calculate dominant orientations for the first and second devices over a non-zero time period.

59. The apparatus as claimed in claim 52, wherein the apparatus is caused to trigger a second action in response to the apparatus being able to determine both that the first and second devices are observing a common audio scene and that the first and second devices are not similarly oriented.

60. The apparatus as claimed in claim 59, wherein the apparatus is caused to perform the second action by being caused to indicate to a user that an alternative orientation is not needed.

61. The apparatus as claimed in claim 52, wherein the apparatus is server apparatus.

62. The apparatus as claimed in claim 52, wherein the apparatus is the second device.
